(19) United States
(12) Patent Application Publication
(10) Pub. No.: US 2013/0326354 A1
(43) Pub. Date: Dec. 5, 2013

(54) Systems and Methods for Selection and Personalization of Content Items

(71) Applicant: James Anderson, New York, NY (US)

(72) Inventor: James Anderson, New York, NY (US)

(21) Appl. No.: 13/487,098

(22) Filed: Jun. 1, 2012

(51) Int. Cl. G06F 3/048

(52) U.S. Cl. 715/733; 715/764

(57) ABSTRACT

A system, computer-readable storage medium storing at least one program, and a computer-implemented method for selecting and personalizing content items, including but not limited to advertisements, are disclosed. A content item is selected from a plurality of content items. The selection is based at least in part on first information relating to a user's interactions with the electronic device. Each content item is associated with code that, when executed, personalizes the content item for the user based at least in part on second information relating to the user's interactions with the electronic device. The code associated with the selected content item is executed to personalize the selected content item. The content item is presented to the user.

### TECHNICAL FIELD

The disclosed ideas relate generally to selecting and personalizing content items, such as advertisements, for presentation to a user in both online and offline environments.

### BACKGROUND

Many services and applications offered to computer users, such as search services, media streaming services, and the like, are supported by advertising revenues. Specifically, advertisers pay the service or application provider to display ads to the users of the service or application. However, not all ads will be relevant to all users of a service or application. Moreover, ads often have the most impact, and hence the highest value to the advertiser, when they are specifically relevant to the needs or wants of the viewer. For example, ads for a women's clothing store may have the most impact when delivered to female users rather than male users. Thus, it would be beneficial to provide a system whereby ads presented to a user of a service or application are relevant to that user. Further, while ads can be delivered to users of a service or application via a network (e.g, the Internet), ads should also be able to be displayed when the user's computer or mobile device is not connected to the network. In order to provide the most effective ads, and hence increase the benefit to the user, the advertiser, and the service provider, these ads should also be relevant to the user at the time the ads are displayed. It would be beneficial, therefore, to provide a system whereby advertisements are relevant to a user despite the fact that the user's computer or mobile device is offline.

### SUMMARY OF THE INVENTION

Accordingly, there is a need for systems and methods that intelligently select and personalize content items, in both online and offline contexts, that are made relevant to the user at the time that the ad is displayed. In accordance with some implementations, a method is performed at an electronic device having one or more processors and memory storing one or more programs. The method includes selecting a content item from a plurality of content items, wherein the selection is based at least in part on first information relating to a user's interactions with the electronic device, and wherein each content item is associated with code that, when executed, personalizes the content item for the user based at least in part on second information relating to the user's interactions with the electronic device. The method also includes executing the code associated with the selected content item to personalize the selected content item, and presenting the personalized content item to the user.

In some implementations, the information relating to the user's interactions with the electronic device is selected from the group consisting of information relating to: a currently played media item; a previously played media item; navigation events; playlist generation; playlist modification; radio station selection; social network sharing; and online transactions. In some implementations, the plurality of content items includes one or more items selected from the group consisting of: advertisements; coupons; offers; and games.

In some implementations, the code is included in the content item. In some implementations, the code is associated with an application being executed by the electronic device. In some implementations, the first information is the same as the second information. In some implementations, the first information is not the same as the second information.

In some implementations, personalizing the content item comprises determining text to include in the selected content item. In some implementations, the text is a title of a concurrently played media item; a name of an artist of a concurrently played media item; and/or a name of an actor in a concurrently played media item. In some implementations, the text is from a social network interaction, or refers to one or more recent interactions with the electronic device.

In some implementations, personalizing the content item comprises determining a location to associate with a link that is displayed in association with the selected content item. In some implementations, personalizing the content item comprises determining an image for inclusion into the content item. In some implementations, personalizing the content item comprises determining a video for inclusion into the content item. In some implementations, the content item is a game, and personalizing the content item comprises changing one or more aspects of the game.

In some implementations, the method further comprises receiving the plurality of content items from a server when the electronic device is in an online state; and selecting the content item from the plurality of content items when the electronic device is in an offline state. In some implementations, the method further comprises storing third information relating to the user's interactions with the electronic device when the electronic device is in an offline state; and sending the third information relating to the user's interactions with the electronic device to the server when the electronic device is in an online state. In some implementations, the method further comprises receiving a second plurality of content items from the server, wherein the second plurality of content items are selected based at least in part on the third information relating to the user's interactions with the electronic device.

In accordance with some implementations, a method is performed at an electronic device having one or more processors and memory storing one or more programs. The method includes selecting a content item from a plurality of content items based at least in part on first information relating to a user's interactions with the electronic device; personalizing the content item for the user based at least in part on second information relating to the user's interactions with the electronic device; and presenting the personalized content item to the user.

In accordance with some implementations, a method is performed at an electronic device having one or more processors and memory storing one or more programs. The method includes storing a plurality of content items for offline access, the content items each associated with code that, when executed, personalizes the content item for a user based at least in part on first information relating to the user's interactions with the electronic device. The method further includes selecting a content item from a plurality of content items, wherein the selection is based at least in part on second information relating to the user's interactions with the electronic device. The method further includes executing the code associated with the selected content item to personalize the selected content item; and presenting the personalized content item to the user.

In accordance with some implementations, an electronic device including one or more processors, memory, and one or more programs stored in the memory and configured to be executed by the one or more processors include instructions for performing the operations of any of the methods described above. In accordance with some implementations, a non-transitory computer-readable storage medium has stored therein instructions which, when executed by an electronic device, cause the device to perform the operations of any of the methods described above.

### BRIEF DESCRIPTION OF THE DRAWINGS

The implementations disclosed herein are illustrated by way of example, and not by way of limitation, in the figures of the accompanying drawings. Like reference numerals refer to corresponding parts throughout the drawings.

FIG. 1 is a block diagram illustrating a client-server environment, according to some implementations.

FIGS. 2A-2D are block diagrams illustrating customizable advertisements, according to some implementations.

FIG. 3 is a flowchart of a method for providing content, according to some implementations.

FIG. 4 is a block diagram illustrating a client device, according to some implementations.

FIG. 5 is a block diagram illustrating a server computer system, according to some implementations.

### DESCRIPTION OF EXAMPLE IMPLEMENTATIONS

Advertisements, are most effective when they are relevant to their audience. In the context of online or web-based ads (e.g., banner ads), various methods have been used to identify ad content that is of interest to the viewer, such as by selecting ads based on recent internet search queries. For example, a coffee shop chain may pay to have its ads displayed when a user enters a search query containing the word “coffee” into an internet search engine. Ads may also be displayed to a user based on media that the user is currently consuming. For example, if a user is streaming a song by The Beatles from an online music service, advertisements that are somehow relevant to The Beatles may be selected and presented to the user (e.g., ads for Beatles merchandise, Beatles albums, music of similar bands, etc.).

One problem with traditional online or computer-based advertising systems, however, is that they are unable to provide highly relevant ads when the user is offline. Even if the advertising system were able to store ads on a user's device (e.g., computer, mobile phone, etc.) for offline access, it would be difficult to know what ads might be relevant to the user at what times. For example, it would be difficult to know, ahead of time, that the user might listen to a song by The Beatles, and that ads relevant to that band should be pre-loaded onto the user's device so that they can be displayed to the user in an offline context. It could require pre-loading and storing thousands of ads on the user's device to ensure that relevant ads would be consistently displayed to users when they were offline. But downloading and storing these ads for offline access would require substantial data transmission and local storage space. This is especially problematic for mobile devices, such as mobile phones, tablet computers, audio players, etc., where storage space is in short supply, and data transmission is expensive.

Further, many advertisers use advertising or marketing content in the context of time-sensitive campaigns, where advertising or marketing items expire or become less relevant at some future time. For example, a coupon or offer may expire at a predefined date, and should not be displayed to a user after that date. In another example, an advertisement for a time-sensitive promotion, such as a “Memorial Day Sale” should not be displayed after Memorial Day has passed. Where a device is in constant communication with an online ad serving system, it relatively easy for these ads to be removed from the ad queue when they expire so that they will not be displayed to a user when they are no longer relevant. This is possible because the content items can be kept up to date in real-time. But where advertisements are downloaded and stored for later offline access, however, it is necessary to ensure that they are not presented to a user after they have expired. These expiration events can be taken into account in the intelligent selection process described herein, regardless of whether the user's device has an active network connection.

The present disclosure addresses these and other problems by providing systems and methods for intelligent selection and personalization of content items, such as advertisements, offers, coupons, media, and the like. While the present discussion frequently refers to advertisements, the ideas disclosed apply equally to other content items that would benefit from the intelligent selection and personalization systems and methods described, such as coupons, offers, rewards, media content (e.g., videos, music, images), etc. In accordance with some implementations, ads can be intelligently selected so that they are relevant to a user at the time of execution, and the selected ads can then be personalized to further increase their current relevance to the user. Specifically, an ad is selected according to some selection criteria. The ad is then processed, which includes executing code that customizes the ad in some way. This two-part process, including intelligent advertisement selection coupled with intelligent advertisement customization, generates ads with a high degree of relevance to a user. Moreover, because the ads are independently customizable, fewer individual ads are necessary in order to provide maximum relevance. That is, one ad in the present system may take the place of multiple (possibly hundreds or thousands, or even millions) of ads in a traditional system, all without diminished relevance to a user. Indeed, the advertisements of the present system may even be more relevant than those of traditional systems, while simultaneously requiring less storage and data transmission. The disclosed systems and methods thus provide for ads that are highly pertinent to the user while having a minimum impact on storage and network usage, making it possible to provide ads with a high degree of immediate relevance in both online and offline contexts.

Furthermore, personalizing ads on the client device, rather than a remote server, allows use of more detailed personal information without raising user privacy concerns. Specifically, information that users may object to having sent to a remote computer for logging and/or analysis can be included in the client-side ad personalization. For example, users may object to having a remote server log all of their media consumption habits, social network postings, “favorited” media, search queries, etc. Thus, it may be too invasive to use this type of information for server-based ad personalization. By placing the ad personalization functionality on the client device, however, it is possible to use this information without such concerns. Thus, an ad may be configured to extract text from a social networking post or a web-search query to display in the ad without that information leaving the client device. (In some implementations, users must “opt in” to an advertising system that uses information that might be considered confidential, personal, or sensitive, even if such information never leaves the client device.)

In some cases, the advertising selection and personalization described herein may be implemented in applications and devices that are commonly used in both online and offline contexts. For example, a media player application on a computer or mobile device may be configured to allow a user to playback locally and remotely stored media (e.g., audio or video files). One advantage of such an application is that the user can transition between online and offline environments with little or no interruption in functionality. But if the application is configured to display ads to the user (e.g., as an ad-supported application might), it should be able to do so equally well in both online and offline contexts without degradation in the quality or relevance of the ads (to either the user, the advertiser, or the service provider). The systems and methods described below satisfy these and other needs.

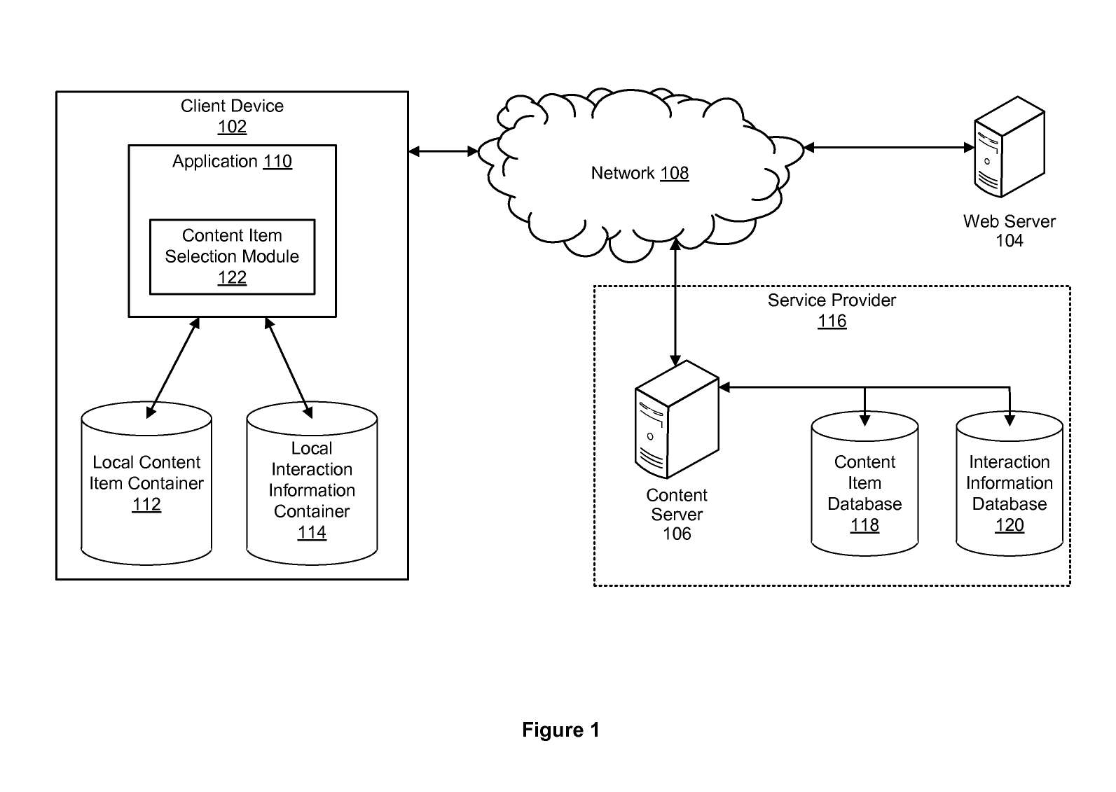

Attention is now directed to the Figures, and in particular FIG. 1, which illustrates a block diagram of a client-server environment, according to some implementations. The client-server environment includes a client device 102, a web server 104, a content server 106, and a network 108.

The client device 102 includes an application 110, a local content item container 112, and a local interaction information container 114. The client device 102 is any device or system that is capable of storing and presenting content items to a user. For example, the client device 102 can be a laptop computer, a desktop computer, tablet computer, mobile phone, television, etc. Moreover, the client device 102 can be, or can be part of, another device, such as (without limitation) a set-top-box, a television, a digital photo frame, a projector, a smart refrigerator, or a “smart” table.

The application 110 is configured to select, personalize, and present content items to a user, in addition to any other function (such as media playback, web browsing, etc.). In some implementations, the application 110 includes a content item selection module 122 to select content items based on one or more criteria. In some implementations, the application is a media player, a game, a web browser, etc.

The web server 104 communicates (e.g., via network 108) with the client device 102. In some implementations, the client device 102, or an application running on the client device 102, requests web pages or other content from the web server 104. The web server 104, in turn, provides the requested content to the client device 102.

The content server 106 communicates (e.g., via network 108) with the client device 102. The content server 106 also communicates with a content item database 118 and an interaction information database 120. In some implementations, the content server 106, the content item database 118, and the interaction information database 120 are all associated with a service provider 116. The content item database 118 contains content items, such as advertisements, coupons, offers, etc., that are sent to client devices (e.g., client device 102) and stored in the local content item container 112. The interaction information database 120 contains interaction information received from client devices (e.g., client device 102). In some implementations, the content server 106 also provides media content to the client device 102. For example, in implementations where the application 110 is a media player, the application 110 may request media content from the content server 106, which in turn sends the requested media content to the client device 102. Media content, includes, but is not limited to, audio, video, images, and text.

Returning to the client device 102, the local content item container 112 contains content items, such as advertisements, coupons, offers, etc., for presentation to a user. The local interaction information container 114 includes information relating to the user's interactions with the client device 102 and/or the application 110 (i.e., interaction information). In some implementations, the local content item container 112 and the local interaction information container 114 comprise memory, such as one or more magnetic disk storage devices, optical disk storage devices, flash memory devices, or other non-volatile solid state storage devices.

In some implementations, the local interaction information container 114 stores information relating to (but not limited to): a currently played media item (audio, video, game, etc.), previously played media items, navigation events, playlist generation, playlist modification, radio station selection, social network sharing, online transactions, web browsing history, web search history, click-through information, mouse click/hover information, and the like. Interaction information may consist of, without limitation, the title, artist, and/or album of a song, or the title or actors of a movie or video that the user has played or is playing. Interaction information may also be a record identifying a recently visited website (e.g., a URL), or a category of a recently visited website (e.g., “eCommerce”). Interaction information may also be information relating to the content of, the recipient of, and/or the sender of a social networking post. Moreover, interaction information can relate to detailed information about these subjects (e.g., the contents of a playlist or the genre of a custom radio station), or simply the occurrence of an event (e.g., the fact that a user recently generated a playlist, or the fact that a user posted to a social network).

In some implementations, interaction information includes information about a user's interactions with previously displayed advertisements. For example, interaction information may include click-through information, web-search history following display of an advertisement, mouse click/hover information, etc. Such interaction information can be used by the service provider 116 to help build a profile of a particular user in order to further tailor advertisement selection algorithms. Also, the service provider 116 may use this information for various purposes, such as to determine the effectiveness of the ads and to establish ad pricing (such as where advertisers are charged on a per-click basis, or in order to determine general pricing structures for ads). Also, an advertiser may use this information to monitor one or more aspects of a campaign that includes, but is not limited to, advertisements, offers, and/or coupons. Such information can be used for many purposes, such as to track an advertising or marketing campaign's effectiveness. For example, an advertiser may compare click-through-rates of ads that used different selection and/or personalization criteria in order to determine what population of people was most receptive to the ad. Such information can then be used by an advertiser or service provider to modify campaigns based on the information.

In some implementations, the content server 106 provides content items (e.g. advertisements) to the client device 102. As described below, in some implementations, content items are sent from the content server 106 to the client device 102 when the client device 102 has an active network connection (i.e., is online). In some implementations, the content items are sent to the client device 102 in response to a request by the application 110. In some implementations, the particular content items that are sent to the client device 102 are selected by the content server 106 based at least in part on interaction information associated with a user of the client device 102 and/or the application 110. In some implementations, the content server 106 determines what content items to send to the client device 102 based at least in part on interaction information stored in the interaction information database 120. Examples of interaction information are discussed above with reference to the local interaction information container 114.

In some implementations, the content server 106 receives interaction information from multiple client computers for storage in the interaction information database 120. Interaction information may be associated with a particular client computer, or a particular user of a client computer. In some implementations, the content server 106 selects the content items to be sent to particular client computers based at least in part on the interaction information stored in the interaction information database 120 and associated with that computer (or a user of that computer). The content server 106 may use the interaction information for a particular user to determine what content items or types of content items would be of interest to the user. For example, if the interaction information for the user indicates that the user has recently listened to several rock songs, the content server 106 may provide to that user's computer content items (e.g., ads) that are relevant to people who typically listen to rock music, or that relate directly to rock music. As another example, if the interaction information for the user indicates that the user routinely clicks on ads that relate to cars, the content server 106 may provide to that user's computer content items (e.g., ads) that relate to cars. In some implementations, before selecting content items to send to the client device 102, the content server 106 receives interaction information from the client device 102 and updates the interaction information database 120 so that content items may be selected using the user's most current interaction information.

In some implementations, the content server 106 creates and maintains a profile of one or more users associated with a client computer. As noted above, the content server 106 periodically receives updated or additional interaction information from a client device 102, which is used to supplement and/or modify the user profile. The content server 106 can then use the updated or additional interaction information for various purposes, such as analyzing the effectiveness of previously submitted ads, updating the user's profile to ensure that the subsequent ads sent to the client device 102 are relevant to the user, etc.

In some implementations, the client device 102 and/or the application 110 may be configured to store interaction information in the local interaction information container 112, and upload the interaction information to the content server 106 at a predetermined time, or according to a predetermined schedule. For example, the application 110 may be configured to upload stored interaction information to the content server 106 each hour, day, week, or at any other interval. In some implementations, the application 110 uploads interaction information to the content server 106 when the client device 102 regains a network connection after a period of offline use.

As described above, content items are selected for presentation to the user based at least partially on interaction information. For example, an ad for a car company may be selected for display because a user of the client device 102 recently posted a vehicle-related post to a social network, or because the user just created a playlist that included numerous songs relating to vehicles. As another example, an ad for an upcoming concert may be selected based on a user's recent selection of an album by that same artist, or based on the amount of time that a user played a particular media item (e.g., an audio track or a video).

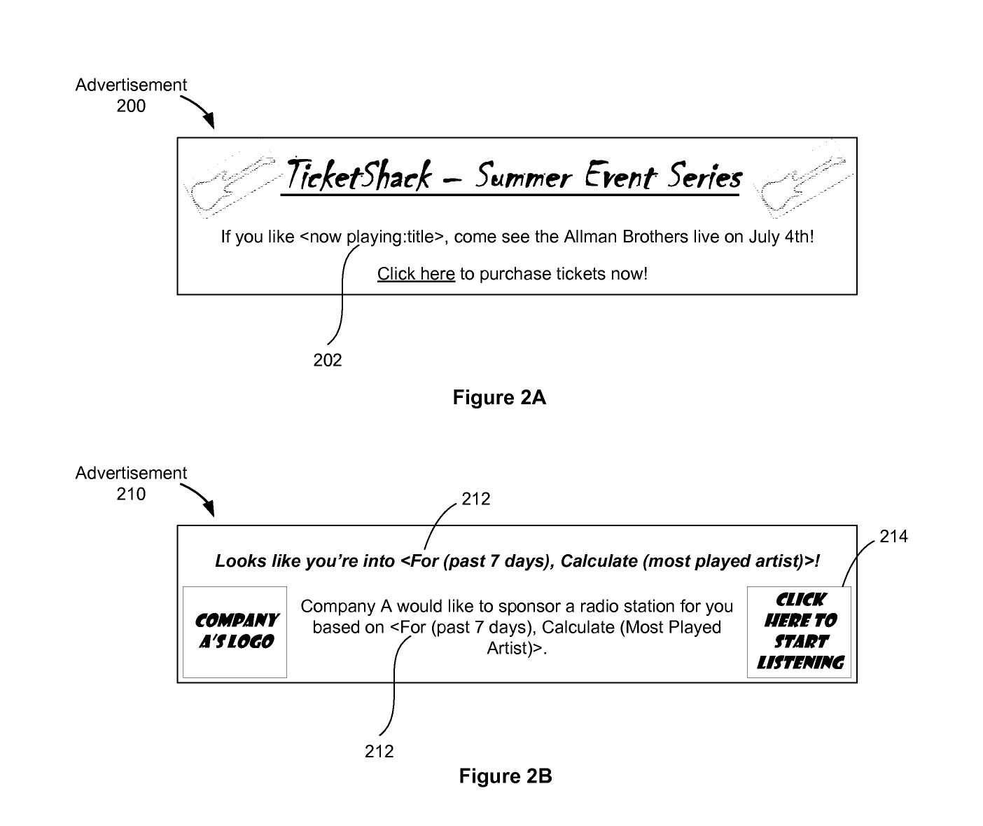

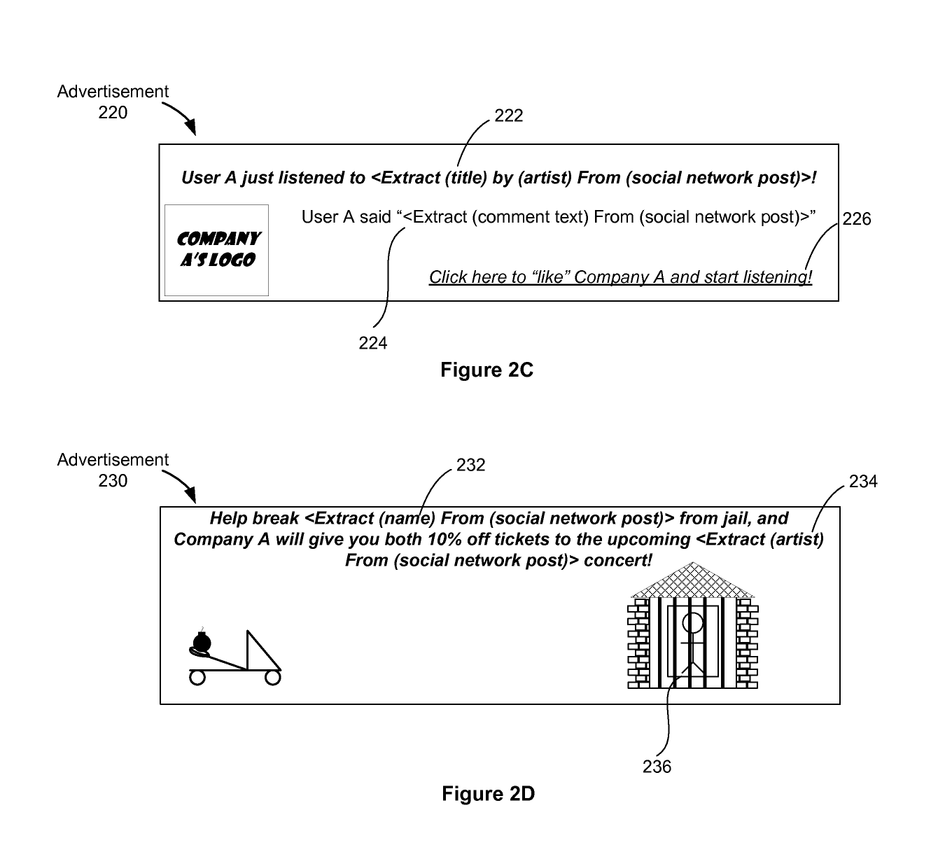

In addition, content items are also configured to be personalized after they are selected so they can be made even more relevant to the user's interests or activities. Personalization can include selecting, calculating, determining, or otherwise setting various aspects of a content item, such as the content item's size, patterns, images, fonts, link addresses, colors, animations, content, etc. Continuing the example from above, an ad that is selected based on a user's recent selection of an album by an artist may be further customized, at display-time, to display the name of the song that is playing when the ad is finally presented to the user. FIG. 2A, discussed in greater detail below, illustrates an ad that may be selected and personalized according to this example.

FIG. 2A illustrates a block diagram of a customizable advertisement 200, according to some implementations. Advertisement 200 may be stored in the local content item container 112, and selected for display to the user based on, for example, playback of any song by the Allman Brothers' Band. Advertisement 200 includes both static content and dynamic content. Static content is any content (e.g., text, image, etc.) or parameter (e.g., size, color, font, etc.) of a content item that does not change when the ad is processed for personalization and display. Dynamic content, on the other hand, is any content that is customizable or that may be selected at the time the content item is processed for presentation.

In some implementations, dynamic content is a variable name that, when the ad is processed, is replaced with the current value of the variable. The variable may be any variable associated with the client device 102 and/or the application 110, such as a current artist, current track, current album, and the like. In some implementations, as described below, dynamic content is a script and/or other computer code that personalizes a content item when it is executed. Advertisement 200, for example, includes dynamic content in the form of variable 202, represented as <now playing: title>, that will be replaced with the title of the media item that is being played at the time that the ad is displayed to the user.

Advertisement 200 illustrates how ads (or indeed any content item) can provide highly relevant and personalized information while requiring only minimal data storage and transmission resources. Specifically, at the selection stage, an ad is selected based on some criteria. In some implementations, an ad is selected based on interaction information stored in the local interaction information container 114. In the above example, the selection criterion is the user's selection of any song from any Allman Brothers' album. In the personalization stage, the ad is itself personalized to the user based on some criteria. Advertisement 200 was personalized to display the specific Allman Brothers song that was being played at the time the ad was presented to the user. In order to achieve the same personalization and relevance with traditional advertising systems, it would be necessary to create a unique ad for each Allman Brothers song (over one hundred songs), and to trigger the proper ad only when and if that particular song is played. This would require substantial commitments of data storage and transmission resources, and would still only account for a small fraction of possible actions that a user may take—more than one hundred separate ads just in case the user decides to listen to an Allman Brothers song. By making a single ad customizable, however, the disclosed system is able to provide highly relevant ads—ads that precisely relate to what the user is doing at that moment—with only a single advertisement. This is especially beneficial for mobile devices where storage space is at a premium and data plans have maximum data transfer limits. Moreover, the lower data storage demands allow the present techniques to be used in offline environments without degradation in the relevance or personalization of the displayed ads.

The content item selection and personalization stages disclosed above will often be different for different advertisements, advertisers, or service providers. For example, the type and content of the static and dynamic content of a content item will inform how the selection and personalization of a content item can be implemented most effectively. Advertisement 200, for example, contains several pieces of static content that relate to tickets for an Allman Brothers concert. Specifically, ad 200 includes a static textual reference to the upcoming Allman Brothers concert, as well as the link (“click here”) that is programmed to navigate a web browser of the client device 102 to a ticket purchasing page for the upcoming concert. Accordingly, an appropriate selection criteria for this ad may be that the user is listening to an Allman Brothers song. In other words, this particular ad will make the most sense to the user (and will have the highest relevance) when the user is actually listening to a song by the Allman Brothers. (Of course, ad 200 could also be displayed based on any desired selection criteria, such as when a user plays a song or album of a similar artist.)

The link described above may initiate any appropriate action, such as causing the application 110 to display a ticket purchase page or window, causing the advertisement to present ticket purchase functionality to the user, causing a separate application to perform some action related to ticket purchasing, etc. Additionally, ticket purchasing functionality may be available whether the user's device is online or offline at that time.

Content items that have less specific static content may be associated with different selection criteria. For example, an advertisement may include the following: “Company A loves <now playing:title> too! Click here to try our latest product.” This ad may be selected at any time without significantly affecting its relevance to the user.

Moreover, selection criteria need not relate to a user's media consumption, as was the case for advertisement 200. Rather, ads can be selected based on any information available to the client device 102, such as interaction information stored in the local interaction information container 114. For example, an ad could be selected for display based on a user's history of ordering lunch using an online service, and the ad may be displayed shortly before the user's typical lunch time. FIG. 2B illustrates an advertisement 210 that may be selected in accordance with these criteria. “Company A” referenced in ad 210 may be a food or beverage provider interested in attracting a user's attention immediately before the user makes a routine purchasing decision (e.g., before lunch). By triggering the ad to be presented immediately before the user's usual lunch time, ad 210 can have a high degree of relevance to the user. In addition, when ad 210 is personalized for the user, as discussed below, ad 210 gains additional relevance, increasing the benefit for both the user and the advertiser.

In some implementations, the dynamic content of an advertisement is a script (e.g., JAVASCRIPT, VBSCRIPT, etc.) or other computer code that, when executed, personalizes the ad in some way. For example, advertisement 210 in FIG. 2B contains a script 212 that determines the name of the artist most listened to by the user during the previous week. The script 212 (represented by “<For (past 7 days), Calculate (most played artist)>”) will be executed sometime after the ad is selected for display, thus personalizing the ad based on up-to-the-moment information about the user, and ensuring that it has a high degree of immediate and personal relevance. When the ad is processed for presentation to the user, the script 212 will be executed, and the result of the script will be included in ad 210. In ad 210, the name of an artist would be inserted into the ad so it would read, for example, “Looks like you're into The Beatles!” followed by “Company A would like to sponsor a radio station for you based on The Beatles.” While the above example describes calculating a most frequently played artist, one of skill in the art will recognize that scripts can be used to perform many different kinds of functions and calculations, and thus can be used to personalize advertisements or other content items in many different ways. For example, a script may be used to calculate a most frequently listened to genre, to create custom text based on a recent social networking post, generate playlists similar to recently played media items (e.g., audio or video), etc. A script may also be used to select the appearance or contents of a content item, such as by selecting an image or pattern (e.g., a background image), a video, an animation, a game, a three-dimensional environment, a color, a size, a shape, etc. for the content item. For example, a script may cause an advertisement to have a black background if a user is currently listening to a hard rock song, and a light brown background when the user is listening to a country song.

Advertisement 210 also includes an object 214 containing a link that is configured to, when selected by a user, initiate a radio station based on the result of the script described above. Thus, the link can also be associated with a script or other computer code (not shown in FIG. 2B) that will populate the link with an appropriate command and/or uniform resource identifier (or a portion thereof) when the ad is processed for presentation to the user. In this example, the link could be populated with a name or other identifier of the artist that should be used to “seed” the radio station (e.g., “The Beatles,” or a predefined unique identifier for The Beatles).

While advertisement 210 contains a link that initiates a radio station, links in content items can be configured to perform many different operations when selected by a user. For example, a link may be a uniform resource locator that will cause a browser on the client device 102 to navigate to a particular webpage. In another example, a link can cause a song to be added to a current queue or playlist of songs. In some implementations, links are tied to a script that will cause an action to be performed, either by the client device 102 or another computer (e.g., content server 106, web server 104, etc.). One of skill in the art will recognize that links (or other input mechanisms, such as clickable buttons) in a content item can be configured to cause many different kinds of actions. In some implementations, the scripts and/or computer code that are activated or initiated by a user's selection of a link are themselves customizable so that they are dynamically modified or created when the content item is processed for presentation to a user.

Scripts and/or computer code are illustrated herein as being incorporated into the content items. In these examples, the actual code of the script may reside in the same data structure(s) and/or file(s) as the content item. However, the scripts and/or computer code may reside in any appropriate location. For example, scripts may be incorporated into the application 110 (rather than in the individual content items) and executed when content items that are associated with the scripts are processed for presentation to the user. The scripts may then cause the content items to display certain information or have certain properties based on the results of the execution. In some implementations, advertisements may be understood as a list of specifications that are processed by the client device 102 to generate all the necessary components of the advertisement (e.g., the size, position, content, link addresses, font, images, etc.). Thus, scripts and/or computer code may be incorporated into the ad specifications themselves, or may be separate from the ad specification. Scripts that are separate from the ad specification may populate the ad specification with values or data upon execution.

In some implementations, information from social networks is used for personalizing content items. FIG. 2C illustrates a block diagram of a customizable advertisement 220, according to some implementations. In some implementations, the application 110 allows users to create and post information to one or more social networks. Where the application 110 is a media player, for example, a user can post updates to a social network (through the application 110) indicating what media that user is currently consuming, and including textual comments about that media. For example, a user may create a post that says “Just listened to Rumour Has It by Adele” and may include the comment “What a great song!” Once such information is shared on a social network, advertisement 220 can incorporate that information when it is processed for display to another user. Specifically, advertisement 220 includes a script 222 to extract song information from a social network posting and a script 224 to extract a comment from a social network posting. When processed for presentation, ad 220 will thus include the song information and the comment text within the ad. Ad 220 also includes a link 226 that, when selected, initiates the playback of the song identified from the social network posting. Thus, ad 220 may include or be associated with a script and/or computer code that populates the link 226 with an appropriate command and/or uniform resource identifier (or portion thereof) when the ad is processed for presentation to the user.

In some implementations, content items include interactive content, such as a game. In some implementations, the game itself is personalized at the time of execution to include or refer to information that is relevant to the user at that time. FIG. 2D illustrates a block diagram of a customizable advertisement 230 that includes a game, according to some implementations. Advertisement 230 includes an example interactive game where a user must catapult a bomb at a jail in order to help a “friend” break free. Advertisement 230 includes a script 232 to extract a name of a person with whom the user recently interacted on a social network. Advertisement 230 also includes a script 234 to extract a name of an artist that was identified in the social networking post. Advertisement 230 may be selected for display in response to detecting that a user has recently engaged in a social conversation with another user regarding an artist that has an upcoming concert. (As there may be many upcoming concerts for many different artists, this advertisement may be frequently relevant to users of social networks, especially where the social networks include media sharing and social commenting functionalities.) The game in advertisement 230 also includes customizable content in the form of image 236, which may be a photo of the person with whom the user recently interacted on the social network. In some implementations, the photo 236 is taken from one or more photos of the user's friend that are available to the user via a social network, for example, by virtue of the “friendship” between the user and that friend.

The game described with reference to FIG. 2D is merely one example of how interactive content in a content item may be personalized according to the present ideas. As another example, a content item is a “portal” into a virtual world, where a user can cause an avatar to interact with other avatars (either human operated avatars, or computer-based avatars). The avatars in the portal may be customized to appear like a user's contacts in a social network. As yet another example, a content item may be a game where aspects of the game (e.g., identity of opposing or friendly characters, game play paths, appearance of other characters, etc.) are customized as the game is played. Customizations in this example may include or be triggered based on information relating to currently or recently played media items, contacts in a social network, content of social network posts, and the like. Also, an advertiser or service provider may provide in-game messages to the user, such as by providing extra lives, bonus levels, in-game purchases or upgrades, etc. Where the content items are intended as advertisement or marketing vehicles, the user can be alerted to the provider of these features: “Company A would like to give you another shot at that level!”

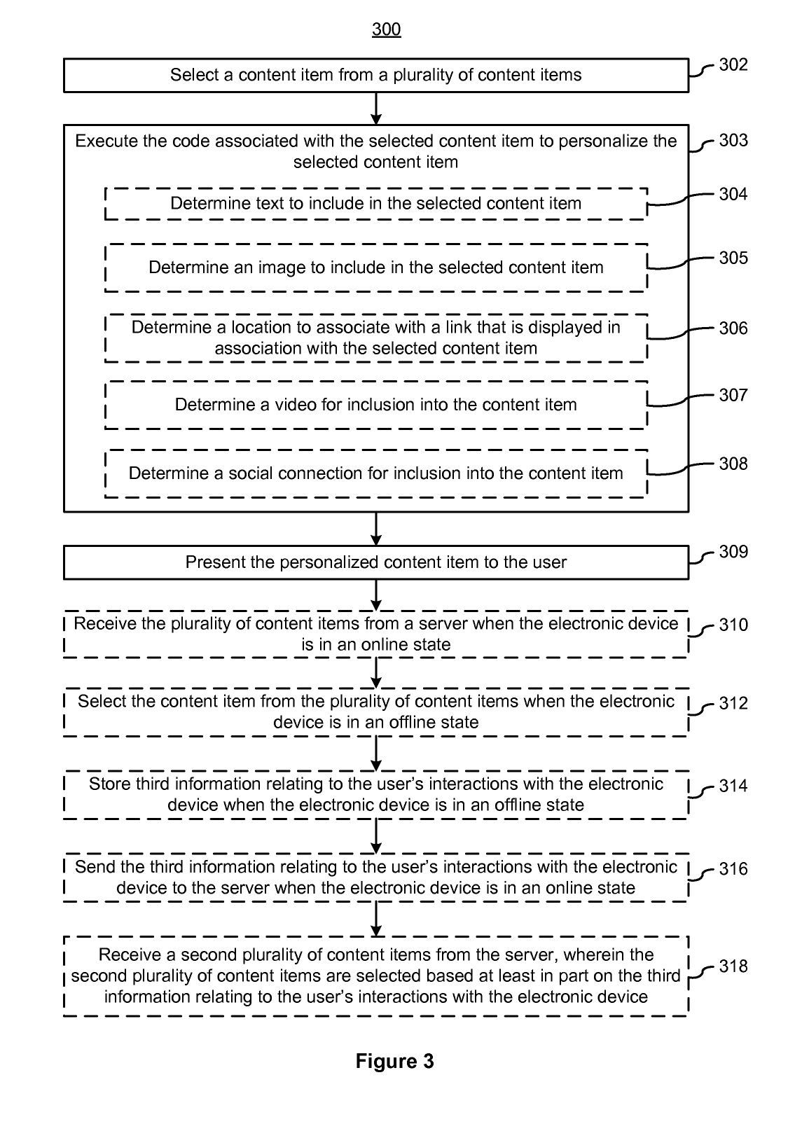

FIG. 3 is a flow chart representing a method 300 for providing content, according to some implementations. The method 300 is performed at a client computer (e.g., the client device 102) having one or more processors and memory, the memory storing instructions (e.g., programs) for execution by the processor. In some implementations, one or more portions of the method 300 are performed when the client computer has no active network connection (e.g., is offline).

The method 300 comprises selecting a content item from a plurality of content items (302). In some implementations, the content item is an advertisement. In some implementations, the plurality of content items was received from a server computer (e.g., content server 106). The content item may be selected by the content item selection module 122 of the application 110.

The selection is based at least in part on first information relating to a user's interactions with the electronic device. Information relating to a user's interactions with the electronic device (i.e., interaction information) is described in detail above, and includes information relating to media consumption, web navigation, social media actions (e.g., posting, commenting, etc.), mouse clicks, and the like. In some implementations, the interaction information is stored on a client device (e.g., client device 102). In some implementations, the interaction information is stored on a server (e.g., content server 106).

Each content item of the plurality of content items is associated with code that, when executed, personalizes the content item for the user based at least in part on second information relating to the user's interactions with the electronic device. In some implementations, the code is included in the content item. In some implementations, the code is not included in the content item. In some implementations, the code is associated with an application being executed by the electronic device.

Second information relating to the user's interactions with the electronic device may be any of the above described information, including information relating to media consumption, web navigation, social media actions (e.g., posting, commenting, etc.), mouse clicks, and the like. In some implementations, the first information relating to the user's interactions with the electronic device is the same as the second information user's interactions with the electronic device. In some implementations, the first information is not the same as the second information.

The method 300 also comprises executing the code associated with the selected content item to personalize the selected content item (303). In some implementations, the code is written in VBSCRIPT. In some implementations, the code is written in JAVA SCRIPT. In some implementations, personalizing the content item comprises determining text to include in the selected content item (304). In some implementations, the text is a title of a concurrently played media item. In some implementations, the text is a name of an artist of a concurrently played media item. In some implementations, the text refers to one or more recent interactions with the electronic device (e.g., a social networking event, web browsing history, search history, etc.). In some implementations, personalizing the content item includes determining an image to include in the selected content item (305). The image may be, without limitation, a background image, a brand logo or trademark, an image associated with currently or previously played media (e.g., a band logo or picture), a picture from a social network (e.g., a profile picture), etc. In some implementations, personalizing the content item comprises determining a location to associate with a link that is displayed in association with the selected content item (306). A location can be, without limitation, a URL to a web page, a portion of a custom URI scheme that causes a client device to perform some action, etc. In some implementations, personalizing the content item comprises determining a video for inclusion into the content item (307). The location may be all or part of a uniform resource indicator associated with the link. In some implementations, personalizing the content item includes any of the personalizations and/or customizations in the foregoing description. In some implementations, personalizing the content item comprises determining a social connection for inclusion into the content item (308). A social connection may be, without limitation, a contact within a social network, or a conversation (e.g., messages, posts, or communications) between two users of a social network. The social connection can be either or both of the content of a connection (such as the text of a message or posting), or the fact of a connection (such as the fact that two users have “favorited” the same media item).

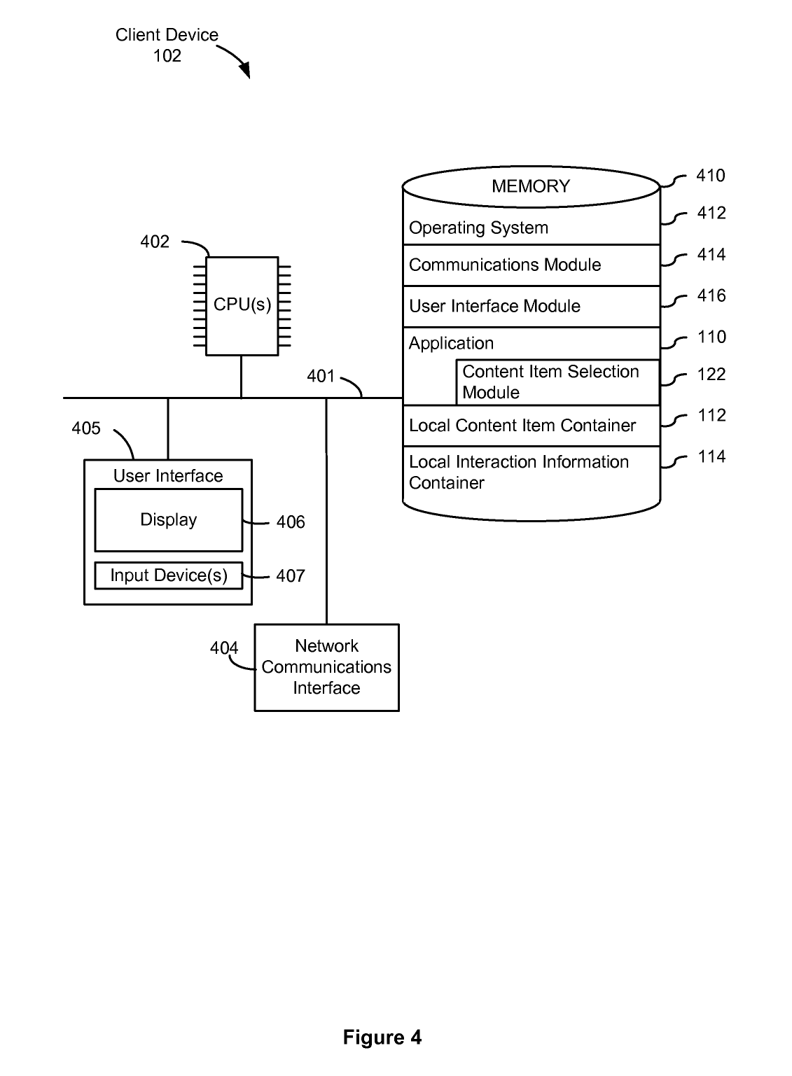

The method 300 also comprises presenting the personalized content item to the user (309). In some implementations, the personalized content item is presented on a display of the electronic device. (e.g., display 406, FIG. 4).

Returning to FIG. 3, in some implementations, the method 300 further comprises receiving the plurality of content items from a server when the electronic device is in an online state (310). In some implementations, the content items are sent to the electronic device (e.g., client device 102) in response to a request from the electronic device. In some implementations, the electronic device sends requests for content items periodically, as described above. In some implementations, the electronic device sends requests for content items when the electronic device regains a network connection after a period in which the electronic device lacked network connectivity (i.e., was in an offline state). In some implementations, the method 300 further selecting the content item from the plurality of content items when the electronic device is in an offline state (312). Thus, content items that are sent to the electronic device when the electronic device was in an offline state are selected (and presented to the user) when the electronic device is in an online state.

In some implementations, the method 300 further comprises storing third information relating to the user's interactions with the electronic device when the electronic device is in an offline state (314). In some implementations, the method 300 further comprises sending the third information relating to the user's interactions with the electronic device to the server when the electronic device is in an online state (316). In some implementations, the interaction information is sent when the electronic device regains a network connection after a period of offline use. In some implementations, interaction information is sent to the server on a periodic basis.

In some implementations, the method 300 comprises receiving a second plurality of content items from the server, wherein the second plurality of content items are selected based at least in part on the third information relating to the user's interactions with the electronic device (318). As described above, in some implementations, a service provider (e.g., service provider 116) creates and maintains a profile of a user based on interaction information received from that user in order to determine what content items to send to an electronic device associated with the user (e.g., client device 102). Then, when the electronic device is to receive content items from the service provider, the service provider selects and sends content items that are likely to be relevant to the user, based on that user's profile. In some implementations, the content items are sent from the content provider to the electronic device when the electronic device has an active network connection, and selected and presented to the user when the electronic device does not have an active network connection.

FIG. 4 is a block diagram illustrating a client device 102, according to some implementations. The client device 102 typically includes one or more processing units (CPUs, sometimes called processors) 402 for executing programs (e.g., programs stored in memory 410), one or more network or other communications interfaces 404, user interface 405, memory 410, and one or more communication buses 401 for interconnecting these components. The communication buses 401 may include circuitry (sometimes called a chipset) that interconnects and controls communications between system components. In some implementations, the user interface 405 comprises a display 406 and input device(s) 407 (e.g., keyboard, mouse, touchscreen, keypads, etc.). In some implementations, the client device 102 is any device or system that is capable of storing and presenting content items to a user. In some implementations, the client device 102 is a mobile device, including, but not limited to, a mobile telephone, audio player, laptop computer, handheld or tablet computer, portable digital assistant, or the like. In some implementations, the client device 102 is any a desktop (i.e., stationary) computer. In some implementations, the client device is, or is incorporated into, without limitation, a set-top-box, a television, a digital photo frame, a projector, a smart refrigerator, a “smart” table, a media player accessory or add-on.

Memory 410 includes high-speed random access memory, such as DRAM, SRAM, DDR RAM or other random access solid state memory devices; and typically includes non-volatile memory, such as one or more magnetic disk storage devices, optical disk storage devices, flash memory devices, or other non-volatile solid state storage devices. Memory 410 optionally includes one or more storage devices remotely located from the CPU(s) 402. Memory 410, or alternately the non-volatile memory devices(s) within memory 410, comprises a non-transitory computer readable storage medium. In some implementations, memory 410 or the computer readable storage medium of memory 410 stores the following programs, modules, and data structures, or a subset thereof:
an operating system 412 that includes procedures for handling various basic system services and for performing hardware dependent tasks;
a communications module 414 that is used for connecting the client device 102 to other computers (e.g., the web server 104, the content server 106, etc.) via the one or more communication interfaces 404 (wired or wireless) and one or more communication networks 108, such as the Internet, other wide area networks, local area networks, metropolitan area networks, and so on;
a user interface module 416 that receives commands from the user via the input device(s) 407 and generates user interface objects in the display device 406;
an application 110 (e.g., a media player, a game, a web browser, etc.) that provides one or more computer-based functions to a user;
a local content item container 112 that stores content items (including, but not limited to, advertisements, media, content, videos, images, interactive games, three-dimensional environments, animations, etc.); and
a local interaction information container 114 that stores information relating to a user's interaction with the client device 102 (including, for example, information about a currently played media item, previously played media items, navigation events, web browsing history, etc.).

The application 110 is any program or software that provides one or more computer-based functions to a user. In some implementations, the application is a media player. In some implementations, the application is a computer game. In some implementations, the application is a web browser. The application 110 may communicate with the web server 104, the content server 106, as well as other computers, servers, and systems.

In some implementations, the application 110 includes a content item selection module 122. The content item selection module 122 selects content items for presentation to the user. In some implementations, the content item selection module 122 is part of the application 110. However, in some implementations, it is separate from the application 110. Indeed, in some implementations, it is associated with multiple applications on the client device 102.

In some implementations, the local content item container 112 stores content items that are received from a remote computer, such as the content server 106. In some implementations, content items are advertisements. Content items, including their contents, how and when they are received, and how they are processed by the client device 102 are described above.

In some implementations, the local interaction information container 114 stores information relating to a user's interaction with the client device 102. In some implementations, as described above, the client device 102 sends interaction information that is stored in the local interaction information container 114 to a remote computer (e.g., content server 106).

In some implementations, the programs or modules identified above correspond to sets of instructions for performing a function or method described above, including those described with reference to FIGS. 1-3. The sets of instructions can be executed by one or more processors (e.g., the CPUs 402). The above identified modules or programs (i.e., sets of instructions) need not be implemented as separate software programs, procedures, or modules, and thus various subsets of these programs or modules may be combined or otherwise re-arranged in various implementations. In some implementations, memory 410 stores a subset of the modules and data structures identified above. Furthermore, memory 410 may store additional modules and data structures not described above.

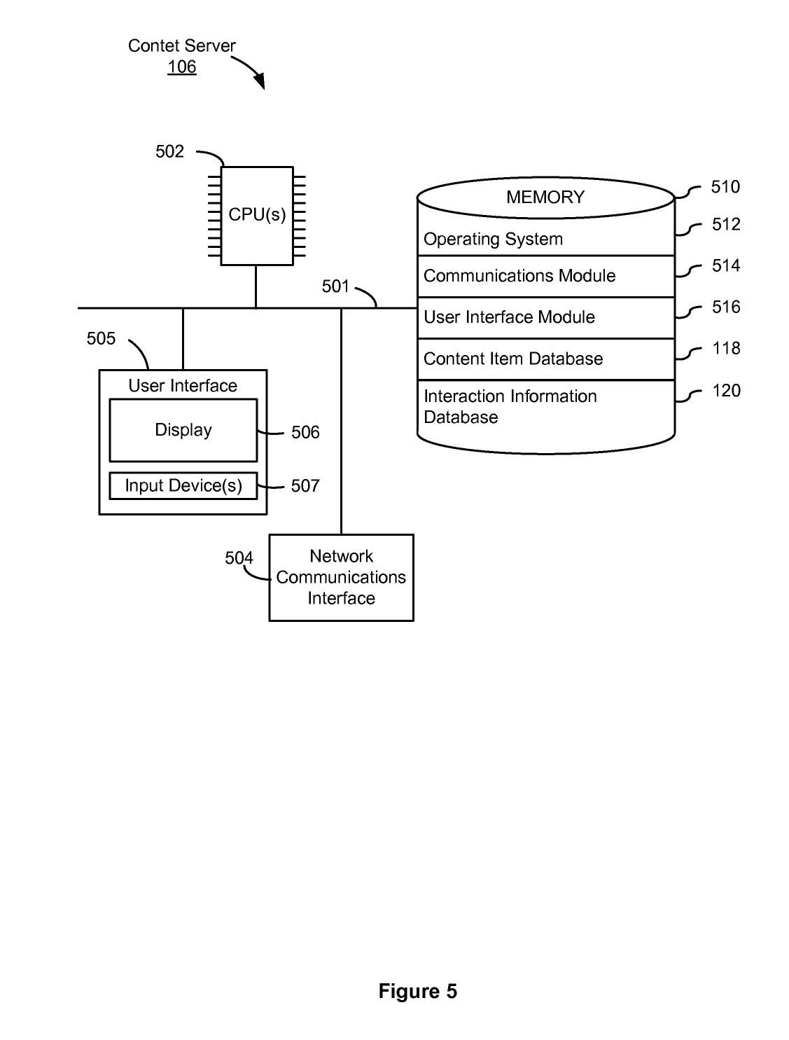

FIG. 5 is a block diagram illustrating a content server 106, according to some implementations. The content server 106 typically includes one or more processing units (CPUs, sometimes called processors) 502 for executing programs (e.g., programs stored in memory 510), one or more network or other communications interfaces 504, an optional user interface 505, memory 510, and one or more communication buses 501 for interconnecting these components. The communication buses 501 may include circuitry (sometimes called a chipset) that interconnects and controls communications between system components. In some implementations, the user interface 505 comprises a display 506 and input device(s) 507 (e.g., keyboard, mouse, touchscreen, keypads, etc.).

Memory 510 includes high-speed random access memory, such as DRAM, SRAM, DDR RAM or other random access solid state memory devices; and typically includes non-volatile memory, such as one or more magnetic disk storage devices, optical disk storage devices, flash memory devices, or other non-volatile solid state storage devices. Memory 510 optionally includes one or more storage devices remotely located from the CPU(s) 502. Memory 510, or alternately the non-volatile memory devices(s) within memory 510, comprises a non-transitory computer readable storage medium. In some implementations, memory 510 or the computer readable storage medium of memory 510 stores the following programs, modules, and data structures, or a subset thereof:
an operating system 512 that includes procedures for handling various basic system services and for performing hardware dependent tasks;
a communications module 514 that is used for connecting the content server 106 to other computers (e.g., the client device 102, the web server 104, etc.) via the one or more communication interfaces 504 (wired or wireless) and one or more communication networks 108, such as the Internet, other wide area networks, local area networks, metropolitan area networks, and so on;
an optional user interface module 516 that receives commands from the user via the input device(s) 507 and generates user interface objects in the display device 506;
a content item database 118 that stores content items (e.g., advertisements); and
an interaction information database 120 that stores interaction information received from other computers (e.g., the client device 102).

In some implementations, the content item database 118 stores content items. In some implementations, content items are advertisements, media, content, videos, images, interactive games, three-dimensional environments, animations, etc. Content items, including their contents, how and when they are received, and how they are processed by the client device 102 are described above. In some implementations, content items are provided to the content server 106 from one or more advertisers, content providers, service providers, etc.

In some implementations, the interaction information database 120 stores information relating to multiple users' interaction with their respective client computers (e.g., client device 102). In some implementations, as described above, client computers send interaction information to the content server 106 periodically. The interaction information database 120 stores the received interaction information in association with an identifier that uniquely identifies the user from which it was received. In some implementations, the interaction information database 120 also stores the user profiles discussed above.

In some implementations, the programs or modules identified above correspond to sets instructions for performing a function or method described above, including those described with reference to FIGS. 1-3. The sets of instructions can be executed by one or more processors (e.g., the CPUs 502). The above identified modules or programs (i.e., sets of instructions) need not be implemented as separate software programs, procedures, or modules, and thus various subsets of these programs or modules may be combined or otherwise re-arranged in various implementations. In some implementations, memory 510 stores a subset of the modules and data structures identified above. Furthermore, memory 510 may store additional modules and data structures not described above.

Although FIGS. 4-5 show client and server computers, these Figures are intended more as functional descriptions of the various features which may be present in these computers than as structural schematics of the implementations described herein. In practice, and as recognized by those of ordinary skill in the art, items shown separately could be combined and some items could be separated. For example, some items shown separately in FIGS. 4-5 could be implemented in single modules or data structures.

Plural instances may be provided for components, operations or structures described herein as a single instance. Finally, boundaries between various components, operations, and data stores are somewhat arbitrary, and particular operations are illustrated in the context of specific illustrative configurations. Other allocations of functionality are envisioned and may fall within the scope of the implementations. In general, structures and functionality presented as separate components in the example configurations may be implemented as a combined structure or component. Similarly, structures and functionality presented as a single component may be implemented as separate components. These and other variations, modifications, additions, and improvements fall within the scope of the described implementations.

The foregoing description, for purpose of explanation, has been described with reference to specific implementations. However, the illustrative discussions above are not intended to be exhaustive or to limit the disclosed ideas to the precise forms disclosed. Many modifications and variations are possible in view of the above teachings. The implementations were chosen and described in order to best explain the principles and practical applications of the disclosed ideas, to thereby enable others skilled in the art to best utilize them in various implementations with various modifications as are suited to the particular use contemplated.

Moreover, in the preceding description, numerous specific details are set forth to provide a thorough understanding of the presented ideas. However, it will be apparent to one of ordinary skill in the art that these ideas may be practiced without these particular details. In other instances, methods, procedures, components, and networks that are well known to those of ordinary skill in the art are not described in detail to avoid obscuring aspects of the ideas presented herein.

It will also be understood that, although the terms “first,” “second,” etc. may be used herein to describe various elements, these elements should not be limited by these terms. These terms are only used to distinguish one element from another. For example, a first server could be termed a second server, and, similarly, a second server could be termed a first server, without changing the meaning of the description, so long as all occurrences of the “first server” are renamed consistently and all occurrences of the “second server” are renamed consistently.

Further, the terminology used herein is for the purpose of describing particular implementations only and is not intended to be limiting of the claims. As used in the description of the implementations and the appended claims, the singular forms “a”, “an” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Finally, as used herein, the term “if” may be construed to mean “when” or “upon” or “in response to determining” or “in accordance with a determination” or “in response to detecting,” that a stated condition precedent is true, depending on the context. Similarly, the phrase “if it is determined (that a stated condition precedent is true)” or “if (a stated condition precedent is true)” or “when (a stated condition precedent is true)” may be construed to mean “upon determining” or “in response to determining” or “in accordance with a determination” or “upon detecting” or “in response to detecting” that the stated condition precedent is true, depending on the context.

What is claimed is:

1. A method for providing content, comprising:
at an electronic device having one or more processors and memory storing one or more programs that when executed by the one or more processors cause the electronic device to perform the method, the method comprising:
selecting a content item from a plurality of content items,
wherein the selection is based at least in part on first information relating to a user's interactions with the electronic device, and
wherein each content item is associated with code that, when executed, personalizes the content item for the user based at least in part on second information relating to the user's interactions with the electronic device;
executing the code associated with the selected content item to personalize the selected content item; and
presenting the personalized content item to the user.

2. The method of claim 1, wherein information relating to the user's interactions with the electronic device is selected from the group consisting of information relating to:
a currently played media item;
a previously played media item;
navigation events;
playlist generation;
playlist modification;
radio station selection;
social network sharing; and
online transactions.

3. The method of claim 1, wherein the code is included in the content item.

4. The method of claim 1, wherein the code is associated with an application being executed by the electronic device.

5. The method of claim 1, wherein the first information is the same as the second information.

6. The method of claim 1, wherein the first information is not the same as the second information.

7. The method of claim 1, wherein personalizing the content item comprises determining text to include in the selected content item.

8. The method of claim 7, wherein the text is a title of a concurrently played media item.

9. The method of claim 7, wherein the text is a name of an artist of a concurrently played media item.

10. The method of claim 7, wherein the text is a name of an actor in a concurrently played media item.

11. The method of claim 7, wherein the text is from a social network interaction.

12. The method of claim 7, wherein the text refers to one or more recent interactions with the electronic device.

13. The method of claim 1, wherein personalizing the content item comprises determining a location to associate with a link that is displayed in association with the selected content item.

14. The method of claim 1, wherein personalizing the content item comprises determining an image for inclusion into the content item.

15. The method of claim 1, wherein personalizing the content item comprises determining a video for inclusion into the content item.

16. The method of claim 1, wherein the content item is a game, and wherein personalizing the content item comprises changing one or more aspects of the game.

17. The method of claim 1, wherein the plurality of content items includes one or more items selected from the group consisting of:
advertisements;
coupons;
offers; and
games.

18. The method of claim 1, further comprising:
receiving the plurality of content items from a server when the electronic device is in an online state; and
selecting the content item from the plurality of content items when the electronic device is in an offline state.

19. The method of claim 18, further comprising:
storing third information relating to the user's interactions with the electronic device when the electronic device is in an offline state; and
sending the third information relating to the user's interactions with the electronic device to the server when the electronic device is in an online state.

20. The method of claim 19, further comprising:
receiving a second plurality of content items from the server, wherein the second plurality of content items are selected based at least in part on the third information relating to the user's interactions with the electronic device.

21. A method for providing content, comprising:
at an electronic device having one or more processors and memory storing one or more programs that when executed by the one or more processors cause the electronic device to perform the method, the method comprising:
selecting a content item from a plurality of content items based at least in part on first information relating to a user's interactions with the electronic device;
personalizing the content item for the user based at least in part on second information relating to the user's interactions with the electronic device; and
presenting the personalized content item to the user.

22. A method for providing content, comprising:
at an electronic device having one or more processors and memory storing one or more programs that when executed by the one or more processors cause the electronic device to perform the method:
storing a plurality of content items for offline access, the content items each associated with code that, when executed, personalizes the content item for a user based at least in part on first information relating to the user's interactions with the electronic device;
selecting a content item from a plurality of content items, wherein the selection is based at least in part on second information relating to the user's interactions with the electronic device;
executing the code associated with the selected content item to personalize the selected content item; and
presenting the personalized content item to the user.

23. An electronic device, comprising:
one or more processors;
memory; and
one or more programs, wherein the one or more programs are stored in the memory and configured to be executed by the one or more processors, the one or more programs including instructions for:
selecting a content item from a plurality of content items,
wherein the selection is based at least in part on first information relating to a user's interactions with the electronic device, and
wherein each content item is associated with code that, when executed, personalizes the content item for the user based at least in part on second information relating to the user's interactions with the electronic device;
executing the code associated with the selected content item to personalize the selected content item; and
presenting the personalized content item to the user.

24. A non-transitory computer-readable storage medium storing one or more programs, the one or more programs comprising instructions, which when executed by an electronic device, cause the device to:
select a content item from a plurality of content items,
wherein the selection is based at least in part on first information relating to a user's interactions with the electronic device, and
wherein each content item is associated with code that, when executed, personalizes the content item for the user based at least in part on second information relating to the user's interactions with the electronic device;
execute the code associated with the selected content item to personalize the selected content item; and
present the personalized content item to the user.
